(19) United States
(12) Patent Application Publication
(10) Pub. No.: US 2012/0112897 A1
(43) Pub. Date: May 10, 2012

(54) SYSTEM AND METHOD FOR MONITORING REMOTE VEHICLE DRIVE CONDITION

(75) Inventors: Chi Nam Oh, Suwon (KR); Kyung Hwan Kang, Seoul (KR)

(73) Assignees: KIA MOTORS CORPORATION, Seoul (KR); HYUNDAI MOTOR COMPANY, Seoul (JP)

(21) Appl. No.: 13/080,065

(22) Filed: Apr. 5, 2011

(30) Foreign Application Priority Data
Nov. 10, 2010 (KR) 10-2010-0111737

(51) Int. Cl. B60Q 1/00

(52) U.S. Cl. 340/439

(57) ABSTRACT

A remote vehicle drive condition monitoring system and a method thereof are provided. The remote vehicle drive condition monitoring system, includes: a vehicle information center configured to receive a set value for monitoring a vehicle drive condition from a user and report a vehicle drive monitoring result to the user; a vehicle terminal configured to receive the set value from the vehicle information center and transmit the vehicle drive monitoring result to the vehicle information center; and a monitoring unit configured to monitor whether a vehicle violates the set value and output the vehicle drive monitoring result.

### CROSS-REFERENCES TO RELATED APPLICATIONS

Priority to Korean patent application number 10-2010-0111737, filed on Nov. 10, 2010, which is hereby incorporated by reference in its entirety, is claimed.

### BACKGROUND OF THE INVENTION

1. Field of the Invention

The present invention relates to a remote vehicle drive condition monitoring system and a method thereof, and more particularly, to a technology for monitoring whether a vehicle violates a set value while driving the vehicle and reporting the result to a user in real time while a vehicle is being driven in response to the a user remotely setting and applying a vehicle set value to a vehicle's driving conditions.

2. Description of the Related Art

The technology for automatically driving a vehicle at constant speed for safely driving a vehicle has been developed, i.e., cruise control. However, there is currently no technique in place which reports to a user, for example, when a vehicle is being driven at a rate of speed that is faster than a desired or set rate of speed. That is, an owner of a vehicle is has no way of knowing whether or not the vehicle is being driven at a safe speed when he or she is not in the vehicle. Accordingly, there remains a need for a technology that provides reports or notifies the owner or user of the conditions or speed in which the vehicle is being driven.

### SUMMARY OF THE INVENTION

The present invention provides a remote vehicle drive condition monitoring system that remotely sets a set value for monitoring vehicle driving by a user and monitors whether a user of the vehicle is driving according to the set value and remotely reporting the monitored result to a user.

In accordance with one embodiment of the present invention, a remote vehicle drive condition monitoring system includes a vehicle information center, a vehicle terminal and a monitoring unit. More specifically, the vehicle information center is configured to receive a set value for monitoring a vehicle drive condition associated with the way a user is driving the vehicle and reporting a vehicle drive monitoring result to the user or owner of the vehicle accordingly. The vehicle terminal is configured to receive the set value from the vehicle information center and transmit the vehicle drive monitoring result to the vehicle information center. The monitoring unit monitors whether a vehicle's current driving condition violates the set value and outputs the vehicle drive monitoring result. The set value may be a driving day, a driving date, an allowable driving time, a prohibited driving zone, or driving speed. The set value may also further include a monitoring term and a monitoring time-period.

In particular, the monitoring unit may report a first violation to the vehicle information center when the vehicle has exceeded, e.g., a set speed when the set value is for vehicle speed. In doing so, the monitoring unit continually checks whether speed of the vehicle is less than or equal to the set speed. When it is determined that the speed of the vehicle is less than or equal to the set speed the monitoring unit may be configured to stop reporting the violation and also stop incrementing a monitoring time-period counter.

In some embodiments of the present invention the monitoring unit may report a first instance of violation to the vehicle information center and check to see whether the vehicle is beyond a set allowable driving zone, when the vehicle travels into a set non-allowable driving zone, e.g., when the set value is for the allowable driving zone. After the first instance of violation has occurred the monitoring unit may continue to check to see whether the vehicle is beyond the allowable driving zone, and continuously reports violations when the vehicle travels in a boundary zone in the checking time. Additionally, when the vehicle travels back into the allowable driving zone the monitoring unit may be configured to stop reporting of the violation. Additionally, if the vehicle again starts traveling into a non-allowable driving zone, the monitoring unit may be configured to again start reporting the violation to the user or owner of the vehicle.

In some embodiments of the present invention, the vehicle information center may report the vehicle drive monitoring results to the user or vehicle owner through, either electronic-mail, a short message service (SMS), a multimedia messaging service (MMS), a telephone, or a website. The More specifically, the monitoring unit may check to see whether the vehicle's current driving conditions violates a set value in real time when the monitoring time-period is not set.

In accordance with another aspect of the present invention, a method of monitoring a remote vehicle drive condition includes: receiving a set value for monitoring a vehicle drive condition from a user at a vehicle information center; transmitting the set value to a vehicle by the vehicle information center; applying the set value to the vehicle and monitoring whether the vehicle violates the set value; and transmitting the monitoring result to the vehicle information center.

In accordance with another aspect of the present invention, a method of monitoring a remote vehicle drive condition further includes: checking whether a current time is within a monitoring term by the vehicle; and performing the monitoring when the current time is the monitoring term.

In accordance with another aspect of the present invention, a method of monitoring a remote vehicle drive condition further includes: reporting the monitoring result to the user or owner of the vehicle by the vehicle information center. That is, the vehicle information center reports the vehicle drive monitoring result to the user or vehicle owner through either electronic-mail, a short message service (SMS), a multimedia messaging service (MMS), a telephone, or a website. The illustrative embodiment of the present invention monitors whether the vehicle violates the set value and reports a first violation to the vehicle information center when the vehicle, e.g., exceeds set speed, for example, when the set value is associated with a vehicle's speed. The system then continually checks to determine whether or not the current speed of the vehicle is less than or equal to the set speed. If the speed of the vehicle is determined to be less than or equal to the set speed, the monitoring unit and stops reporting the violation and stops counting the monitoring time-period.

In some embodiments of the present invention, the method monitors whether the vehicle violates the set value and reports a first violation to the vehicle information center and checks whether the vehicle travels is beyond a set allowable driving zone, e.g., when the set value is an allowable driving zone. In this embodiment the monitoring unit monitors whether the vehicle violates the set value, and checks whether the vehicle has traveled beyond the allowable driving zone. The method then continuously reports violations when the vehicle travels in a boundary zone in the checking time, and stops reporting of the violation when the vehicle travels in the set allowable driving zone. Additionally, the method may again start reporting of violation when the vehicle again travels in a non-allowable driving zone. The set value in this embodiment may be a driving day, a driving date, an allowable driving time, an allowable driving zone, a prohibited driving zone, or driving speed.

Advantageously, the present invention monitors whether a user is driving a vehicle according to a remotely set value and reports the remotely monitored result to a user or owner of the vehicle so that he or she will know of the conditions in which their vehicle is being driven. By receiving this result, the user may remotely confirm whether the vehicle is traveling within conditions set by the user, and instantly recognize whether the vehicle has been stolen or is being driven inappropriately.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a remote vehicle drive condition monitoring system according to an exemplary embodiment of the present invention;

FIG. 2 is a scheme diagram illustrating a remote vehicle drive condition monitoring method according to an exemplary embodiment of the present invention;

FIG. 3 is a graph illustrating a method of monitoring vehicle speed set by a user according to an exemplary embodiment of the present invention;

FIG. 4 and FIG. 5 are views illustrating a method of monitoring whether a driver is driving the vehicle in an allowed driving area set by a user according to an exemplary embodiment of the present invention;

FIG. 6 is a graph illustrating a method of monitoring whether a driver is driving the vehicle in an allowed driving area set by a user according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

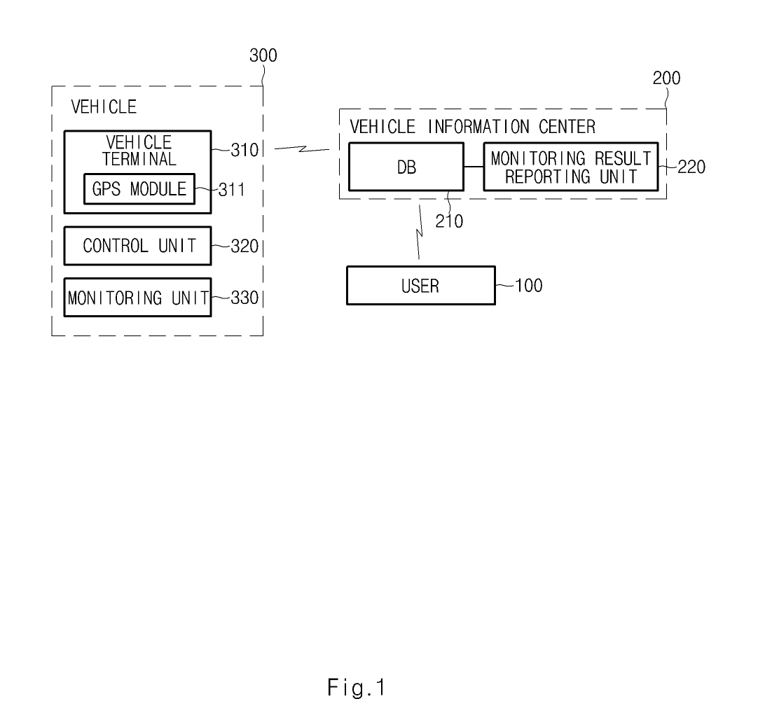

Hereinafter, a remote vehicle drive condition monitoring system and a method thereof will be described with reference to FIG. 1 to FIG. 6.

FIG. 1 is a block diagram illustrating a configuration of a remote vehicle drive condition monitoring system according to an exemplary embodiment of the present invention.

The remote monitoring system and more specifically, vehicle drive condition monitoring system according to an exemplary embodiment of the present invention may be implemented by association of a vehicle 300 and a vehicle information center 200.

The vehicle information center 200 stores a vehicle set value set by a user 100. When the vehicle information center 200 receives a monitoring result from the vehicle 300, it reports the monitoring result to the user. In this case, the vehicle information center 200 may provide a website through the Internet that allows a user to accesses the website and store, change, or remove a vehicle set value, and perform connections with a consultant via a telephone.

To do this, the vehicle information center 200 includes a database 210 and a monitoring result reporting unit 220.

The database 210 stores the vehicle set value set from a user 100 and a monitoring result from the vehicle 300.

The monitoring result reporting unit 220 reports the monitoring result from the vehicle 300 to the user 100 by either electronic-mail (email), a short message service (SMS), a multimedia messaging service (MMS), and/or a telephone.

The monitoring result reporting unit 220 may display a monitoring result through a web page such that a user may access a web page to confirm the monitoring result.

The vehicle 300 also includes a vehicle terminal 310, a control unit 320, and a monitoring unit 330.

The vehicle terminal 310 performs wireless communications with the vehicle information center 200. Accordingly, when the vehicle terminal 310 receives a vehicle set value from the vehicle information center 200, it transfers the received vehicle set value to the control unit 320. When the vehicle terminal 310 receives the monitoring result from the monitoring unit 330, it transmits the received monitoring result to the vehicle information center 200. In this case, the vehicle terminal 310 may be a telematics terminal. Further, since the vehicle terminal 310 may include a global positioning system (GPS) module 311, it collects location information of a vehicle by communicating with a GPS (not shown) and provides current location information of the vehicle to the monitoring unit 330.

When the control unit 320 receives the vehicle set value from the vehicle terminal 310, it applies the received vehicle set value to the vehicle. For example, when the vehicle set value is an allowable vehicle driving time, the control unit 320 sets the allowable vehicle driving time.

The monitoring unit 330 monitors whether a vehicle violates the vehicle set value set by utilizing the control unit 320. Accordingly, when the vehicle violates the vehicle set value, the monitoring unit 330 transmits the monitoring result to the vehicle information center 200 through the vehicle terminal 310.

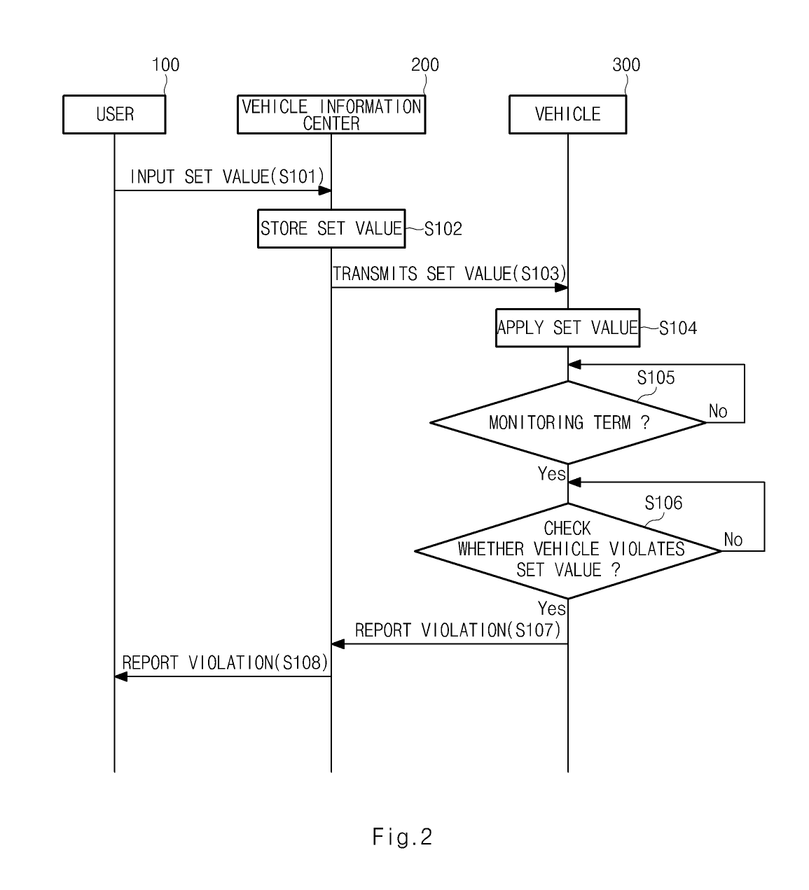

Hereinafter, a remote vehicle drive condition monitoring method according to an embodiment of the present invention will be explained with reference to FIG. 2.

Initially, the vehicle information center 200 receives a set value for monitoring a vehicle driving condition from a user (S101) and stores the received set value (S102). For example, the vehicle information center 200 may receives a set value for monitoring a vehicle drive condition through a web site or a telephone.

Next, the vehicle information center 200 transmits the set value to the vehicle 300 (S103) and the control unit 320 of the vehicle 200 applies the set value to the vehicle to be monitored (S104). In this case, the set value may include a driving day, a driving date, an allowable driving time, an allowable driving zone, a prohibited driving zone, driving speed, a monitoring term, and/or a monitoring time-period.

Accordingly, the monitoring unit 330 of the vehicle 300 checks whether a current time is within a monitoring term set by a user (S105). When the current time is within the monitoring term, the monitoring unit 330 monitors a vehicle according to a monitoring time-period of the vehicle in order to check to see whether the vehicle is violating any of the user set values (S106). For example, when the monitoring term is set to November 1˜November 30, driving monitoring may be performed only when a current time is within the term, e.g., on November 11.

As a checking result of step S106, when the vehicle violates the set value, the vehicle terminal 310 reports the violation (monitoring result) to the vehicle information center 200 (S107), and the vehicle information center 200 reports the monitoring result to the user 100.

As stated above, the vehicle information center 200 may report the monitoring results to the user 100 via either electronic-mail, SMS, MMS, and/or telephone by way of example. However, the user may also access the web server periodically to confirm any monitoring results provided from the vehicle information center 200.

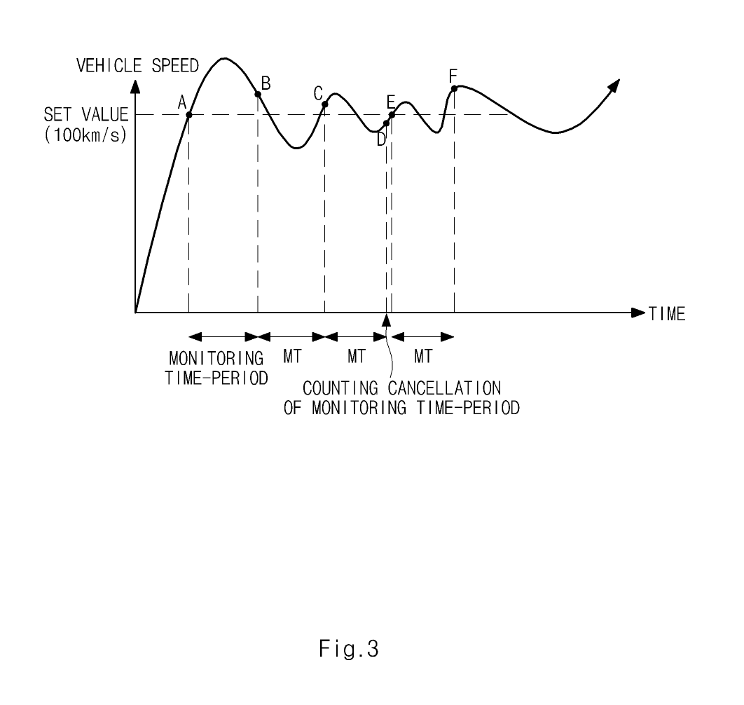

A monitoring method according to the different types (e.g., driving day, driving date, allowable driving time, allowable driving zone, prohibited driving zone, and driving speed) of the set value will now be described with reference to FIG. 3 to FIG. 6 in detail.

First, when the set value is the driving date or the driving day, for example, only Monday, Wednesday, Friday or specific day, the monitoring unit 330 reports violation to the vehicle information center 200 when the vehicle travels on any day except for Monday, Wednesday, Friday or a specific day/date.

Moreover, when the set value is a driving time, for example, from 9 a.m. to 6 p.m., the monitoring unit 330 reports violation to the user through the vehicle information center 200 if the driver drives a vehicle before 9 a.m. or after 6 p.m.

Moreover, when the set value is a driving speed, for example, 100 km/s, the monitoring unit 330 reports a violation to the user 100 through the vehicle information center 200 when the vehicle is being driven at a speed that is higher than 100 km/s (about 62 mph).

As shown in FIG. 3, when a vehicle first reaches a point of 100 km/s, the monitoring unit 330 reports the violation to the vehicle information center 200 and continues to check/monitor the current driving speed of the vehicle during the monitoring period (MT).

Accordingly, when the current driving speed of a vehicle is equal to or greater than 100 km/s during a second period B, the monitoring unit 330 continuously reports violation to the vehicle information center 200, and confirms a current driving speed of the vehicle during a third period C. Since the driving speed of the vehicle is equal to or greater than 100 km/s during a third time-period C, the monitoring unit 330 continuously reports the violation to the vehicle information center 200. Subsequently, because the driving speed of the vehicle is equal to or less than 100 km/s during a fourth time-period D, the monitoring unit 330 stops reporting of the violation to the vehicle information center 200 and also stops counting the monitoring time-period (MT). In turn, when the vehicle again reaches a point of 100 km/s (E), the monitoring unit 330 reports violation to the vehicle information center 200 and again counts a monitoring time-period MT to continuously monitor driving speed of the vehicle during the monitoring time-period MT.

Alternatively, when the set value is an allowable driving zone, for example, “Seoul”, and the vehicle has traveled beyond Seoul, the monitoring unit 330 reports the violation to the vehicle information center 200, and continuously checks to see whether the vehicle is still beyond the “Seoul” or has reentered “Seoul” to report a violation to the vehicle information center 200.

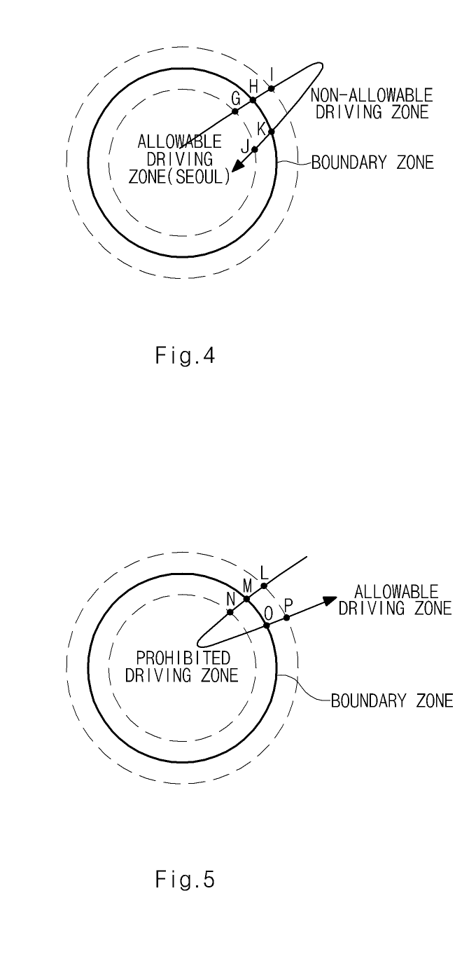

Referring to FIG. 4, when the allowable driving zone is set, and the vehicle passes through point G (allowable driving zone), point H (boundary zone) and reaches point F (non-allowable driving zone), the monitoring unit 330 reports first violation to the vehicle information center 200, and continuously checks a driving zone of the vehicle during every monitoring time-period. Next, when the vehicle passes through point K (boundary zone) and reaches point J (allowable driving zone), the monitoring unit 330 stops reporting of the violation. In this case, the monitoring time-period is set to “0” such that a user can check a vehicle driving zone in real time.

On the other hand, when the set value is a prohibited driving zone, for example, where the prohibited driving zone is set to “Chooncheon”, and the vehicle enters “Chooncheon”, the monitoring unit 330 reports the violation to the vehicle information center 200, and continuously checks to determine whether the vehicle is still within ‘Chooncheon’ during every monitoring time-period to report violation to the vehicle information center 200.

Referring to FIG. 5, when the prohibited driving zone is set, the vehicle passes through point L (allowable driving zone) and point M (boundary point) and reaches point N (prohibited driving zone), the monitoring unit 330 reports first violation to the vehicle information center 200 and continuously checks a driving zone of a vehicle during every monitoring time-period. Subsequently, when the vehicle passes through point O (boundary zone) and reaches point P (allowable driving zone), the monitoring unit 330 stops reporting of violation. In this case, the monitoring time-period is set to “0” such that a user checks a vehicle driving zone in real time.

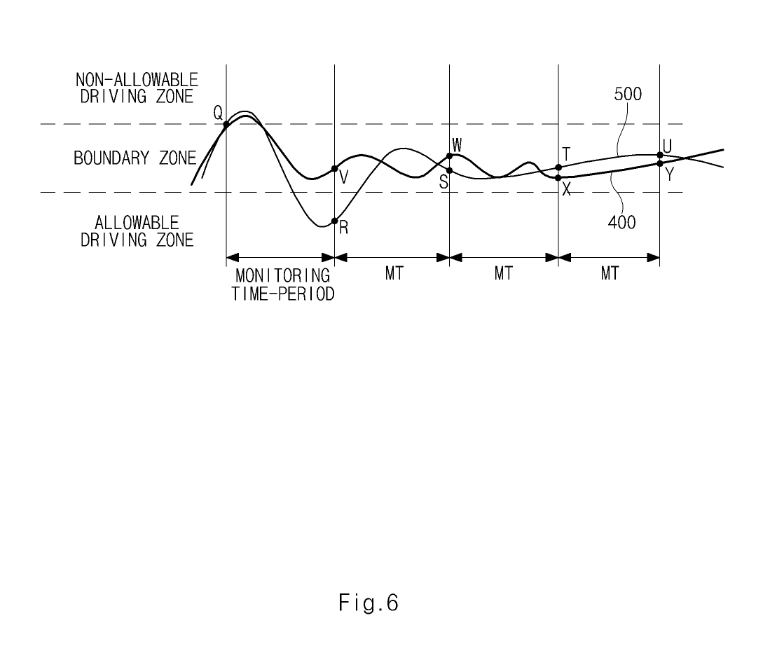

A graph 400 of FIG. 6 illustrates a continuous reporting case of a violation after a first violation of a vehicle has been determined to have occurred. More particularly, a graph 500 of FIG. 6 illustrates a case where reporting violation is stopped after a first violation of a vehicle.

First, referring to the graph 400 of FIG. 6, when a vehicle reaches point Q (non-allowable driving zone), because reporting of first violation has been performed and a vehicle is located within a boundary zone in point V of a second monitoring time-period, the monitoring unit 330 continues reporting of violation. Since point W of a third monitoring time-period, point X of a fourth monitoring time-period, point Y of a fifth monitoring time-period are within a boundary zone, the monitoring unit 330 continues reporting of violation.

Meanwhile, referring to the graph 500, when a vehicle reaches point Q (non-allowable driving zone) after the start of driving, the monitoring unit 330 reports a first violation. Because the vehicle is located within an allowable driving zone in point R of a second monitoring time-period, the monitoring unit 330 stops reporting of violation. Since point S of a third monitoring time-period, point T of a fourth monitoring time-period, point U of a fifth monitoring time-period are all located within a boundary zone but do not enter a non-allowable driving zone, reporting of violation maintains a continuous stop state.

As is seen from the forgoing description, the present invention reports a monitoring result for a vehicle that allows a user to check whether a vehicle is driving in a set condition desired by the user.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A remote vehicle drive condition monitoring system, comprising:
a vehicle information center receiving a set value for monitoring a vehicle drive condition from a user and reporting a vehicle drive monitoring result to the user;
a vehicle terminal receiving the set value from the vehicle information center and transmitting the vehicle drive monitoring result to the vehicle information center; and
a monitoring unit monitoring whether a vehicle violates the set value and outputting the vehicle drive monitoring result.

2. The system of claim 1, wherein the set value is selected from a group consisting of a driving day, a driving date, an allowable driving time, a prohibited driving zone, or driving speed.

3. The system of claim 1, wherein the set value comprises a monitoring term and a monitoring time-period.

4. The system of claim 2, wherein the set value further comprises a monitoring term and a monitoring time-period.

5. The system of claim 1, wherein the monitoring unit reports a first violation to the vehicle information center when the vehicle exceeds a set speed wherein the set value is for vehicle speed, and the monitoring unit checks whether speed of the vehicle is less than or equal to the set speed, and stops reporting of the violation and counting of the monitoring time-period when the speed of the vehicle is less than or equal to the set speed in the checking time.

6. The system of claim 1, wherein the monitoring unit reports a first violation to the vehicle information center and checks whether the vehicle is beyond a set allowable driving zone when the vehicle travels in a non-allowable driving zone, wherein the set value is an allowable driving zone, and the monitoring unit checks whether the vehicle is beyond the allowable driving zone, and continuously reports violations when the vehicle travels in a boundary zone in the checking time, and stops reporting of the violation when the vehicle travels within the set allowable driving zone.

7. The system of claim 5, wherein the monitoring unit stops reporting of the violation and continuously stops the reporting of violation although the vehicle travels in the boundary zone when the vehicle travels in a set allowable driving zone at the checking time, and the monitoring unit again starts the reporting of violation when the vehicle again travels in a non-allowable driving zone.

8. The system of claim 1, wherein the vehicle information center reports the vehicle drive monitoring result to the user through one of a electronic-mail, a short message service (SMS), a multimedia messaging service (MMS), a telephone, or a website.

9. The system of claim 2, wherein the vehicle information center reports the vehicle drive monitoring result to the user through one of a group consisting of an electronic-mail (email), a short message service (SMS), a multimedia messaging service (MMS), a telephone, or a website.

10. The system of claim 5, wherein the monitoring unit checks whether the vehicle violates a set value in real time when the monitoring time-period is not set.

11. The system of claim 6, wherein the monitoring unit checks whether the vehicle violates a set value in real time when the monitoring time-period is not set.

12. A method of monitoring a remote vehicle drive condition, comprising:
receiving a set value for monitoring a vehicle drive condition from a user at a vehicle information center;
transmitting the set value to a vehicle by the vehicle information center;
applying the set value to the vehicle and monitoring whether the vehicle violates the set value by a monitoring unit within the vehicle; and
transmitting the monitoring result to the vehicle information center.

13. The method of claim 12, further comprising:
checking whether a current time is within a monitoring term by the vehicle, and performing the monitoring when the current time is the monitoring term.

14. The method of claim 12, further comprising: reporting the monitoring result to the user by the vehicle information center.

15. The method of claim 14, wherein the vehicle information center reports the vehicle drive monitoring result to the user through one of a group consisting of an electronic-mail (email), a short message service (SMS), a multimedia messaging service (MMS), a telephone, or a website.

16. The method of claim 12, wherein monitoring whether the vehicle violates the set value further comprises reporting a first violation to the vehicle information center when the vehicle is beyond set speed, wherein the set value is a vehicle speed, and monitoring whether the vehicle violates the set value further comprises checking whether the speed of the vehicle is less than or equal to the set speed, and stopping reporting of the violation and stopping counting of the monitoring time-period when the speed of the vehicle is less than or equal to the set speed in the checking time.

17. The method of claim 12, wherein monitoring whether the vehicle violates the set value further comprises reporting a first violation to the vehicle information center and checking whether the vehicle has traveled beyond a set allowable driving zone when the vehicle travels in a set non-allowable driving zone wherein the set value is the allowable driving zone, and monitoring whether the vehicle violates the set value further comprises checking whether the vehicle is beyond the allowable driving zone, and continuously reporting violation when the vehicle travels in a boundary zone within the checking time, and stopping reporting of the violation when the vehicle travels in the set allowable driving zone.

18. The method of claim 17, wherein monitoring whether the vehicle violates the set value further comprises stopping reporting of the violation and continuously stopping the reporting of violation although the vehicle travels in the boundary zone when the vehicle travels in a set allowable driving zone at the checking time, and monitoring whether the vehicle violates the set value again further comprises starting the reporting of violation when the vehicle travels in a non-allowable driving zone.

19. The method of claim 12, wherein the set value is selected from a group consisting of a driving day, a driving date, an allowable driving time, an allowable driving zone, a prohibited driving zone, or driving speed.

20. The method of claim 15, wherein the set value is selected from a group consisting of a driving day, a driving date, an allowable driving time, an allowable driving zone, a prohibited driving zone, or driving speed.
